(19) United States
(12) Patent Application Publication
(10) Pub. No.: US 2014/0359962 A1
(43) Pub. Date: Dec. 11, 2014

(54) WINDSHIELD WIPER/SCRAPER

(71) Applicant: Daniel C. Brown, St. Louis, MO (US)

(72) Inventor: Daniel C. Brown, St. Louis, MO (US)

(21) Appl. No.: 14/269,753

(22) Filed: May 5, 2014

Related U.S. Application Data
(60) Provisional application No. 61/833,528, filed on Jun. 11, 2013.

(51) Int. Cl. B60S 1/38

(52) U.S. Cl. CPC B60S 1/38; B60S 2001/3837
USPC 15/250.41

(57) ABSTRACT

A windshield wiper apparatus comprising a frame, a flexible wiper element and at least one scraper element expanding the length of the frame.

### CROSS-REFERENCE TO RELATED APPLICATIONS

This application claims the benefit of provisional patent application Ser. No. 61/833,528, filed Jun. 11, 2013, which is incorporated herein by reference.

### BACKGROUND

Windshield wipers for automobiles, trucks and other vehicles are known. In general, windshield wipers comprise a frame and a blade. The frame is generally constructed from a rigid material, such as metal. The frame is either bow-shaped or has flex points to allow it to conform to a curved surface of a windshield. The blade comprises a more flexible material, such as a flexible or pliable rubber. The frame is attached to an arm powered by a motor which moves or waves the wiper blade back and forth across the window to remove water and some light materials such as light snow or other debris.

Window wipers of the same general construction are used on the back windows of some vehicles such as vans or sport utility vehicles. Some vehicles employ small wipers on their headlamps.

Although standard windshield wipers work well for the intended purpose of wiping away rain, for example, they do not work well to remove ice. The flexible blades do not have sufficient rigidity or a sharp edge that can remove ice. It would be advantageous, therefore to have a windshield wiper blade that can remove both accumulating rain and ice.

### SUMMARY

A windshield wiper/scraper apparatus comprising both a flexible rain removing blade and scraping structures.

In one aspect the apparatus includes a frame, flexible wiper blade and a plurality of individual scrapers. The scrapers can be position on one side of the length of the flexible blade or on each side of the flexible blade.

In another aspect, the apparatus comprises a frame and flexible wiper blade and a scraper blade extending the entire length of one or both sides of the wiper blade.

In another aspect, the apparatus comprises a flexible wiper blade and a plurality of individual scraping teeth or pins that extend along one or both sides of the flexible wiper blade.

In yet another aspect, the apparatus comprises a flexible wiper blade and a plurality of small scrapers, position in a staggered arrangement along the length of the flexible wiper blade.

The apparatus can consist of interlocking pivoting scrapers with hinged pins, non-interlocking pivoting scrapers, pivoting scrapers without hinged pins, flexible staggered teeth, or one single flexible scraper blade. The material of said scrapers can consist of any rigid material such as plastic, metal or the like capable of removing ice or other hard debris from windows/windshields.

In another aspect, the flexible blade, the scraping structures or both may be provided separate from the frame and installed in a frame by the user.

### DESCRIPTION OF THE DRAWINGS

FIG. 1A is a perspective view of one aspect of the wiper/scraper apparatus;

FIG. 1B is cross-sectional view taken along line 1B-1B of FIG. 1A;

FIG. 2A is a perspective view of one aspect of the wiper/scraper apparatus;

FIG. 2B is a cross-sectional view taken along line 2B-2B of FIG. 2A;

FIG. 3A is a perspective view of another aspect of the wiper/scraper apparatus;

FIG. 3B is a cross-sectional view take along line 3B-3B of FIG. 3A;

FIG. 4 is a bottom plan of a section of another aspect of the wiper/scraper apparatus;

FIGS. 5 is a bottom plan of a section of another aspect of the wiper/scraper apparatus;

FIG. 6A is a perspective view of another aspect of the wiper/scraper apparatus; and

FIG. 6B is a cross-sectional view taken along line 6B-6B of FIG. 6A.

### DETAILED DESCRIPTION

A windshield wiper assembly or apparatus is disclosed comprising a frame, a wiper element and a scraper element for scraping snow, ice or debris from a window. In general the apparatus is employed in a vehicle having a windshield and windshield wiper system comprising motor driven wiper arms with wiper blade assemblies attached to the wiper arm. The motors effect back and forth movement of the wiper blade assemblies across the windshield. Although reference is made to a windshield, it should be understood the assembly also can be used on a rear window or on headlamps that employ wipers.

It will be understood that the three primary elements, frame, wiper element and scraper element may be provided as separate parts. For example, the original equipment frame may be employed and the wiper element or scraper element installed in the frame. Any combination of original equipment and scraper element is intended to be encompassed by the claims.

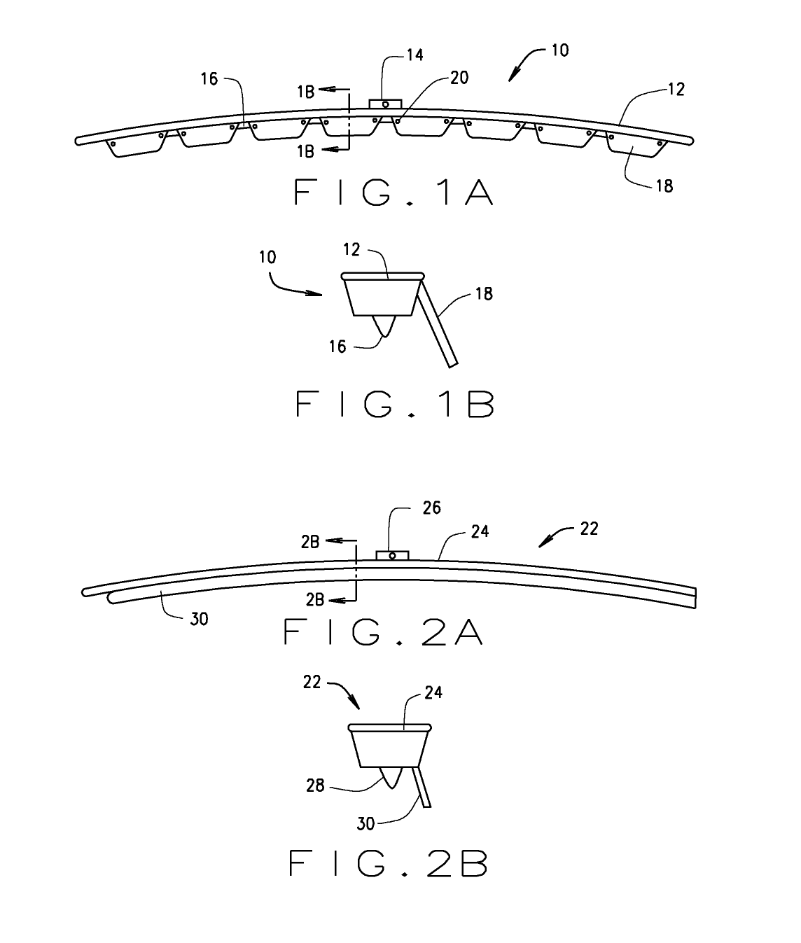

One aspect of the wiper/scraper apparatus is shown in FIGS. 1A and 1B and indicated generally by number 10. Apparatus 10 is intended to mount in a windshield wiper frame 12. Frame 12 includes attachment means 14 for attaching the apparatus to a wiper arm (not shown) that effects movement of the apparatus across a surface, for example the surface of a vehicle windshield. In general, in a vehicle the wiper arm is motor driven to effect movement of the wiper/scraper apparatus across the surface of the window.

Apparatus 10 may comprise a flexible wiper blade 16. Flexible wiper blade 16 is suspended in frame 12 as known to the art and generally extends the length of frame 12. Wiper blade 16 may be constructed from a resilient, flexible material such as rubber or the like.

As shown, wiper/scraper 10 includes a plurality of individual scraper elements 18 positioned along the length of the frame 12. Scraper elements or scrapers 18 can be positioned on one side of wiper blade 16, as seen in FIG. 1B, or can be position on both sides of the wiper blade. There can be individual hinges or hinge pins 20 securing the scrapers to a frame (or to each other) to allow the fame to bend for flex as needed. Scrapers 18 comprise a substantially rigid material, such as plastic or metal or any such material. The edges of the scrapers may be beveled or angled so as to give the scraper a sharp edge or surface.

FIGS. 2A and 2B illustrate another aspect of the apparatus, indicated generally by number 22. Apparatus 22 is mounted in a frame 24 that has attachment means 26 for attachment to a windshield wiper arm, an optional wiper blade 28 and a single scraper element 30 that extends the length of frame 12 along one side of the wiper blade 28. There can be a scraper element 30 on each side of wiper blade 28, if desired. Scraper element 30 is sufficiently rigid to effect scraping, but flexible enough to conform to the contour of the surface.

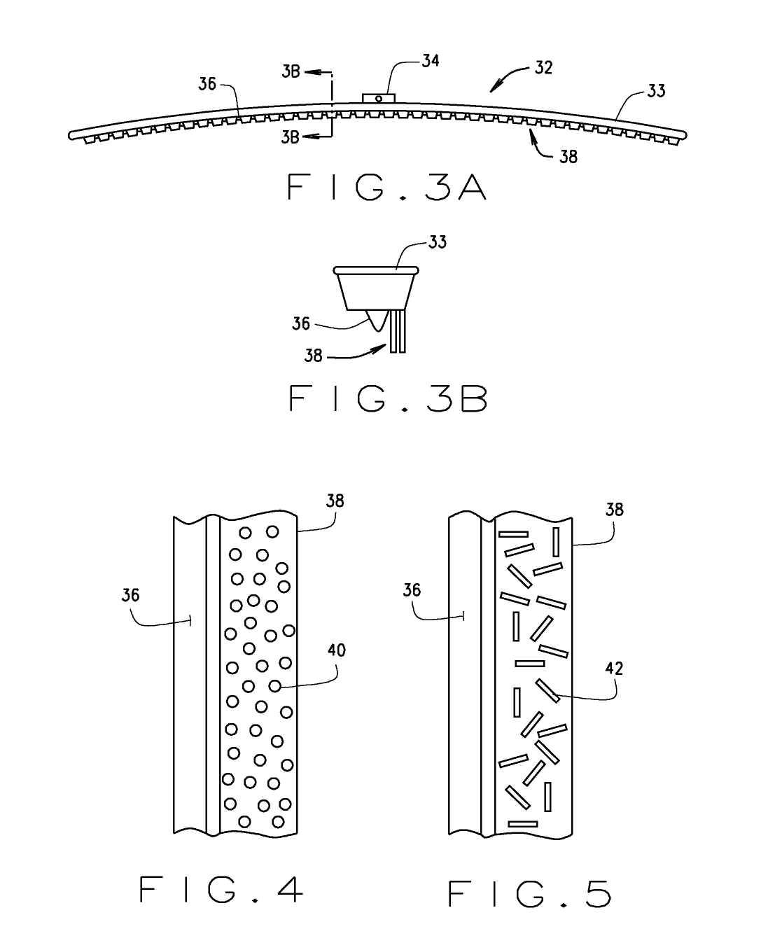

Another aspect of the apparatus is indicated generally by number 32 in FIGS. 3A and 3B. Apparatus 32 is mounted in a frame 33 which includes attachment means 34. Apparatus 32 comprises an optional wiper blade 36 and scraper element 38.

As shown, scraper element 38 comprises individual rigid teeth or pins 40, as shown in greater detail in FIG. 4. The teeth are staggered and allow for the apparatus to flex to conform to a curved surface.

FIG. 5 illustrates yet another aspect of a scraper element with as small or mini scraping blades 42 arranged in a staggered configuration. As with previous embodiments, teeth or pins 40 or scraping blades 42 extend the length of the frame and can be positioned on one side of wiper blade 36 or both sides.

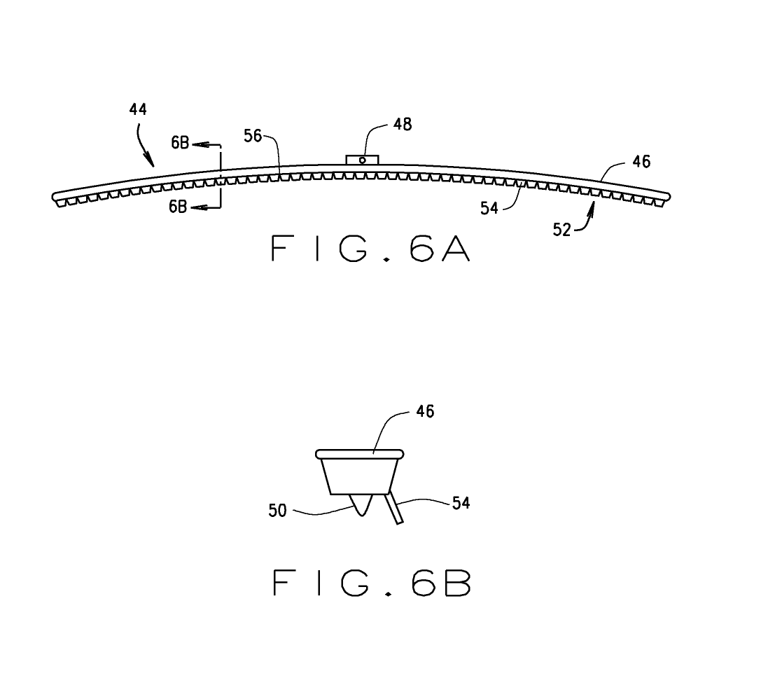

FIGS. 6A and 6B illustrate another aspect of the apparatus indicated generally as number 44 and comprising a frame 46, attachment means 48, wiper blade 50 and a scraper 52 extending the length of frame 46 and comprising a plurality of individual scraper elements 54. Scraper 52 can be constructed as a one piece element having flex areas 56 of reduced material thickness between the scraper elements 54 or the scraper elements can be connected by hinge pins to allow for flexing of the scraping blade. There can be a scraper 52 along one side of wiper blade, as shown, or along both sides.

It will be appreciated that various changes and modifications may be made in the apparatus without departing from the scope of the description. Any windshield wiper that comprises a scraper element or wiper blade and scraper element is intended to be encompassed. For example, the apparatus can comprise one unit, having a frame, wiper blade and scraper element together, rather than separate elements. Separate elements have the advantage of allowing replacement of worn parts without replacing the entire unit.

1. A window wiper comprising:
a frame; and
at least one substantially rigid scraper element mounted in the frame.

2. The window wiper of claim 1 further comprising a flexible wiper element mounted in the frame.

3. The window wiper of claim 1 wherein the at least one substantially rigid scraper element extends the length of the frame.

4. The window wiper of claim 1 comprising a plurality of spaced apart scraper elements positioned along the length of the frame.

5. The window wiper of claim 4 wherein the scraper elements are pivotally attached to the frame.

6. In a vehicle having a window and associated window wiper system having at least one motor driven window wiper, said window wiper comprising:
an elongated frame; and
at least one scraper element affixed to the frame.

7. The window wiper of claim 6 further comprising a flexible wiper element affixed to and extending the length of the frame.

8. The window wiper of claim 6 wherein the scraper extends the length of the frame.

9. The windshield wiper of claim 6 comprising a plurality of spaced apart scraper elements along the length of the frame.

10. The window wiper of claim 6 wherein the flexible wiper element comprises rubber.

11. The window wiper of claim 7 wherein the scraper element comprises a substantially rigid material.

12. The window wiper of claim 6 wherein the scraper element comprises plastic.

13. In a vehicle having at least one window and at least one window wiper system having at least one motor driven window wiper, said window wiper including a frame, a scraper mounted in the frame, comprising:
an elongated body dimensioned to mount in the frame, said elongated body including at least one substantially rigid scraper element.

14. The scraper of claim 13 wherein the scraper element spans the length of the elongated body.

15. The scraper of claim 13 wherein the scraper element comprises a plurality of individual scraping elements.

16. The scraper of claim 15 wherein the plurality of scraping elements are aligned across the length of the body.

17. The scraper of claim 11 wherein the scraper element is attached to a flexible wiper blade.
